(19) United States
(12) Patent Application Publication
(10) Pub. No.: US 2009/0068069 A1
(43) Pub. Date: Mar. 12, 2009

(54) Article having reduced metal contamination

(76) Inventors: Masao Yamase, Kanagawa (JP); Ryuta Yamaguchi, Kanagawa (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/919,034

(22) PCT Filed: Mar. 29, 2006
(86) PCT No.: PCT/JP2006/306519

§ 371 Date: Oct. 22, 2007

(30) Foreign Application Priority Data
Apr. 27, 2005 (JP) 2005-130142

(51) Int. Cl. B01J 19/02

(52) U.S. Cl. 422/129

(57) ABSTRACT

[Problems] To provide a means for preventing metal contamination for articles to be used in fields in need of reduced metal contamination.

[Means for Solving] An article has a titanium oxide film formed over portions to be in contact with a liquid or portions to be in contact with a vapor.

### TECHNICAL FIELD

The present invention relates to fields in need of reduced metal contamination, for example, to fields where processes such as cleaning and delamination are carried out in relation to objects such as semiconductor wafers.

### BACKGROUND ART

Cleaning and delamination processes for semiconductors are processes that are repeated a number of times in a semiconductor device fabrication flow and are techniques for maintaining substrate surfaces clean, for effectively removing particles and metal contamination and the like and for delaminating resists and high molecular weight films. Cleaning modes in a cleaning process include wet cleaning and mechanical cleaning and, at present, the wet type cleaning is absolutely in the mainstream.

Under such circumstances, the present inventors have proposed, in Patent Reference 1, an article processing technique for implementing a process that minimizes damages to substrates in cleaning and delamination processes, is low in cost and damage and is environmentally friendly.

Patent Reference 1: Japanese Unexamined Patent Publication No. 2004-349577

### DISCLOSURE OF THE INVENTION

### Problems to be Solved by the Invention

Conventional vapor generators needed strength as heat-resistant and pressure-resistant vessels due to the need to heat pure water to high temperatures (100 to 200° C.) in order to generate vapor. As such, metals such as cast iron and stainless steel were mainly used. From these metals, however, heavy metals (iron, chromium and the like) that elute into the pure water and vapor as well as metal ions (aluminum and the like) also known as metal contamination that are harmful to semiconductor fabrication are carried along with the vapor to locations where the vapor will actually be used, such as process reaction chambers and cleaning chambers, representing a factor for markedly decreasing the yield of semiconductor fabrication and the like by such metal contamination. It is then contemplated that a non-metallic material such as Teflon resin (Teflon is a registered trademark) is used for vapor generators. When such a material is used, however, the resin may be charged, causing a significant problem for semiconductor fabrication processes, in addition to the problems of heat resistance (usually 200° C. or lower) and pressure resistance (usually impractical to be used for high-pressure vessels as a resin alone).

### Means for Solving the Problems

After conducting a keen examination for the primary purpose of preventing metal contamination of articles to be used especially in fields in need of reduced metal contamination and for the secondary purpose of preventing static electrification, the present inventors have attained the following inventions (1) to (12).

The present invention (1) is an article having a titanium oxide film formed over portions to be in contact with a liquid or portions to be in contact with a vapor. The “liquid” of the “portions to be in contact with a liquid” herein is not particularly limited as long as it is one in which metal ions will be dissolved or to which metals will migrate to cause a problem, examples of which include ultrapure water. The “vapor” of the “portions to be in contact with a vapor” herein is not particularly limited as long as it is one in which metal ions will be dissolved or to which metals will migrate to cause a problem, examples of which include water vapor. The “titanium oxide” refers to an oxide of titanium including oxidized titanium. The “article having a titanium oxide film formed” is a concept wherein a titanium oxide does not have to be formed over the whole part of an article, but only has to be formed over portions to be in contact with a liquid or portions to be in contact with a vapor. Further, the substance composing a film does not entirely have to be a titanium oxide, and other titanium compounds (a hydroxide of titanium, for example) may also be included as inevitable components. In addition, the titanium oxide film is not necessarily limited, but is preferably one that indispensably contains titanium monoxide (and, additionally, titanium dioxide, in some cases). The “article” is not particularly limited as long as it may contact with a liquid or vapor. Also, a component composing such an article is included in the “article” according to the present invention.

The present invention (2) is the article according to the invention (1) wherein the titanium oxide film is an oxidized titanium film. The thickness of the titanium oxide film is not particularly limited, but is preferably 5 nm or more, more preferably 7.5 nm or more, and even more preferably 10 nm or more. The upper limit is not particularly limited, but is preferably 200 nm or less. Here, the values of film thicknesses are determined on the basis of ESCA and those that are too large to be determined by ESCA are to be determined on the basis of SEM and the like.

The present invention (3) is the article according to the invention (1) or (2) wherein the oxidized titanium film is a naturally oxidized film that is formed by naturally oxidizing titanium. Here, the “natural oxidizing” refers to a treatment in which a naturally oxidized film is created over a pure titanium surface.

The present invention (4) is the article according to the invention (3) wherein the natural oxidizing uses pure water and/or vapor under the presence of oxygen. Here, it is preferable to bring the pure water and/or the vapor at an elevated temperature so that the growth of oxidized film may be promoted. The “elevated temperature” refers to one preferably 100° C. or higher, and more preferably 150° C. or higher.

The present invention (5) is the article according to the invention (3) or (4) wherein the titanium surface is cleaned prior to the natural oxidizing.

The present invention (6) is the article according to the invention (5) wherein the cleaning is acid wash. Here, the “acid” refers to dilute hydrochloric acid, dilute nitric acid and dilute hydrofluoric acid, for example.

The present invention (7) is the article according to any one of the inventions (1) to (6) which is an article in need of reduced metal contamination. Here, the “article in need of reduced metal contamination” refers to an article for which contamination by trace metals may cause a problem, examples of which include articles for semiconductor processes, articles for liquid crystal processes, articles for analyzers and articles for medical uses. Preferable articles have such a property that the total amount of metals eluted when placed in ultrapure water is 1 ppb or less (more preferably 0.5 ppb or less, and even more preferably 0.1 ppb or less). In addition, preferable articles have such a property that the amount of a single metal eluted when placed in ultrapure water is 0.02 ppb or less. Here, the values of the amount of eluted metals as determined represent values determined on the basis of inductively coupled plasma mass spectrometry (ICP-MS) after placing the article in ultrapure water at 80° C. for 30 minutes. Here, the “metal” refers to any metal for which contamination may cause a problem in connection with applications, examples of which include all metals or, for example, Al, Fe, Cr, Ni, Cu, Na, Mg, Ca, K, Zn, Ti, Ba, Pb, Pt, Y, W, Mn, Cs, Mo, Zr, Ir, Sr, Bi, each or any combinations thereof.

The present invention (8) is the article according to the invention (7) wherein the article in need of reduced metal contamination is an article for semiconductor processes, an article for liquid crystal processes, an article for analyzers or an article for medical uses. Here, the “article” is not particularly limited as long as it may be in contact with a liquid or vapor for use in various applications described above, examples of which include tubes, vessels, nozzles, valves and sensors.

The present invention (9) is the article according to the invention (8) wherein the article for semiconductor processes is a vapor generator or a component related thereto to be used in one of the processes for cleaning, delamination and processing of semiconductors. Here, the “vapor generator or a component related thereto” is a concept which includes not only a such generator and a component composing the generator but also all related components involved in the path up to the vapor generator and the path from the vapor generator to a workpiece. For example, vessels, heaters, safety valves, stop valves, pressure reducing valves, orifices for regulating vapor flow rate, pressure detectors, pure water level detectors and pipings for vapor may be mentioned, for example. Further, the type of this vapor generator is not particularly limited and they may be of the type of directly heating pure water by a heater (see FIG. 5), the type of radiantly heating pure water by a heater (see FIG. 6) or the type of indirectly heating pure water by a heater (see FIG. 7). In these figures, “a” denotes a heater, “b” denotes a vessel, “c” denotes pure water and “d” denotes vapor.

The present invention (10) is the article according to the invention (9) wherein metal contamination of a wafer after using article for the semiconductor processes is 5E+10 atoms/cm² or less (preferably 1E+10 atoms/cm² or less) for each metallic element alone.

The present invention (11) is a processed titanium material which is naturally oxidized to be converted into the article according to any one of the inventions (1) to (10). Here, the “processed titanium material” refers to a material having the same composition as the article according to any one of the inventions (1) to (10) except that a titanium oxide film is not substantially formed.

### EFFECT OF THE INVENTION

The present invention (1) is characterized that a titanium oxide film is formed over an article. Here, it is known that titanium materials are more electrically conductive and mechanically strong in comparison with resin and quartz materials and more heat-resistant, such as less thermally expandable, in comparison with stainless steel and the like. However, it has been found anew for creating clean vapors containing less metal contamination that a titanium oxide film is effective in preventing elution of metallic impurities remaining in a minimum amount in a titanium material, in addition to being stable in a variety of environments, capable of maintaining strength of a titanium material, more heat-resistant and corrosion-resistant than titanium itself and highly hydrophilic to be excellent in heat conduction to and from pure water. Thus, according to the present invention (1), even using a titanium material rather low in purity, such as pure titanium for industrial uses, that is more suitable for processing of high-pressure vessels, instead of an expensive pure titanium material containing only a minimum amount of impurities, such an effect is obtained that elution of the metallic impurities contained in the titanium material may be prevented when in contact with a liquid or vapor, in addition to the effects based on the various properties mentioned above.

According the present inventions (2) to (4), since a particularly effective oxidized titanium film is formed, such an effect is obtained that the effects mentioned for the invention (1) may be enjoyed for a prolonged period of time. Further, such an effect in production is obtained that the film may naturally be formed, in contrast to an anodized film that is formed under special conditions. Further, according to the present invention (4), as a result of the film formation with more metallic impurities having been removed from the titanium surface, such an effect is obtained that elution of the metallic impurities from the portions to be in contact with a liquid or the portions to be in contact with a vapor may further be minimized.

According to the present inventions (5) and (6), since the titanium surface is cleaned (acid washed) prior to the natural oxidizing, with a result that the oxidized titanium film formed after the cleaning contains only a minimum amount of metallic impurities, such an effect is obtained that elution of the metallic impurities from the portions to be in contact with a liquid or the portions to be in contact with a vapor may further be minimized.

According to the present invention (7), since the amount of eluted metals is extremely small, such an effect is obtained that use may be possible in a variety of applications where metal elution in an ultratrace amount causes a problem. In particular, in semiconductor processes, since 1 ppb or less is required (in future, a specification of 0.1 ppb or less may be required) in contrast to a cleaning process after wafer polishing that is allowed under a cleaning atmosphere with a cleaning solution and the like in the order of 10 ppb, it is very beneficial for use in such processes.

According to the present inventions (8) to (10), in a variety of applications where elution of metallic impurities in an ultratrace amount causes a problem [for example, semiconductor processes (for example, cleaning step and wet etching step)] such an effect is obtained that the amount of eluted metallic impurities may minimally be suppressed to improve the yield of products (for example, semiconductor products) in spite of being in an environment where the metallic impurities tend to elute with the use of a vapor at a high temperature.

According to the present invention (11), such an effect is obtained that it may be useful as a material (intermediate) for providing the articles according to the inventions (1) to (10).

### BEST MODE FOR CARRYING OUT THE INVENTION

The present invention will be described in detail by way of example with a semiconductor processing device as an article in need of reduced metal contamination. The technical scope of the present invention is in no way limited to such an example and it is needless to say that articles to be used in fields that are not all relevant to semiconductor processing may fall within the range of the present invention as long as they are in need of reduced metal contamination and the art of the present invention is applied.

First Best Mode

With reference to FIG. 1, an overall configuration of a semiconductor processing device according to the first best mode will now be described. The device is composed of a nozzle 101, an operative valve 103, a water flowmeter 105, stop valves 107a and 107b, a water pressurizing tank 111 (replaceable with a water feeding pump), a water vapor generator 113, water supply pipes 115a and 115b, a nitrogen supply pipe 117, a pressure reducing valve 119, pressure-resistant pipes 121 to 123 and a stage 131. Positioned on the stage 131 is an object to be processed (for example, a semiconductor wafer) 133. The nozzle 101 is positioned so as to face the object 133 and generates a two-fluid jet of water vapor and pure water. If the supply of the pure water is stopped, then the water vapor will only be spurted.

The water pressurizing tank 111 pressurizes pure water supplied from the water supply pipe 115b to a predetermined value A₁ (MP) and feeds a predetermined flow rate B₁ (l/min) of the pressurized pure water under a high pressure through the pressure-resistant pipe 121 to the nozzle 101. (Depending on the nozzle shape, the pure water may be fed without being pressurized). The water flowmeter 105 measures the flow rate of the pure water supplied from the water pressurizing tank 111 to the nozzle 101. The operator can confirm the flow rate at the water flowmeter 105 and adjust it to a desired value using the operative valve 103. In addition, the stop valve 107a may be opened or closed to stop or resume the supply of the pure water.

The water vapor generator 113 warms the pure water supplied from the water supply pipe 115a to a predetermined temperature D₁ (° C.) or higher to generate water vapor and feeds it under a high pressure through the pressure resistant pipe 123 to the nozzle 101. A pressure meter 120 measures the pressure of the water vapor supplied from the water vapor generator 113 to the nozzle 101. The operator can confirm the pressure at the pressure meter 120 and adjust it to a desired value using the pressure reducing valve 119. In addition, the stop valve 107b may be opened or closed to stop or resume the supply of the water vapor.

Within the nozzle 101, a process for cleaning, polishing or grinding is carried out with use of the pure water supplied from the water pressurizing tank 111 and the water vapor supplied from the water vapor generator 113.

The configuration is made so that nitrogen may be supplied from the nitrogen supply pipe 117 to the water pressurizing tank 111. In this manner, with the use of water containing other gases or liquid chemicals added (for example, CO₂, O₃, N₂, O₂, N₂, alkalis, acids, surface active agents and the like), cleaning capacities and polishing or grinding rates may be increased. Although nitrogen is mixed into pure water in this best mode, it is apparent that pure water may only be supplied to the nozzle 101. Also, this nitrogen gas (replaceable with an inert gas such as Ar gas) can fill up the vessel of the vapor generator in case of a system shutdown, thereby simultaneously acting to prevent the inner surface of the vessel from being exposed to an atmosphere containing impurities and extraneous objects in large amounts.

Specific Numerical Values

(1) Specific numerical values within the water pressurizing tank 111

Pressure of pure water A₁ (MP)=0.1 to 0.5 (MP)

Flow rate of pure water B₁ (l/min)=0 to 1.0 (l/min)

(2) Specific numerical values within the water vapor generator 113

Pressure of water vapor C₁(MP)=0.1 to 0.6 (MP)

Temperature of water vapor D₁ (° C.)=100 to 160 (° C.)

(3) Clearance E₁ (spacing) between the surface of an object and the jet port of the nozzle 101

Spacing E₁ (mm)=1 to 100 (mm)

Preferable Nozzle Shape

FIG. 2(a) and FIG. 2(b) illustrate respectively first and second exemplary shapes of the nozzle 101 to be preferably used in an object processing device according to this best mode. In FIG. 2(a), 201 denotes a jet port of the pressure resistant pipe 123 from the water vapor generator 113 and 203 denotes a jet port of the pressure resistant pipe 121 from the water pressurizing tank 111. The jet ports 201 and 203 are provided through the wall of the nozzle 101 in a direction perpendicular to the jet port of the nozzle 101, first 203 and then 201 in order of proximity to the jet port. In FIG. 2(b), 205 denotes a jet port of the pressure resistant pipe 123 from the water vapor generator 113 and 207 denotes a jet port of the pressure resistant pipe 121 from the water pressurizing tank 111. The jet port 205 is provided through the wall of the nozzle 101 and the jet port 207 is led through the pressure resistant pipe 121 into the nozzle 101 and is determined in its position so that the pure water may be spurted in the vicinity of the jet port of the nozzle 101. In either of FIG. 2(a) and FIG. 2(b), an opening corresponding to the diameter (1 to 12 mm φ) or cross section of the nozzle opening is preferable. The shape of the opening is optimized according to the object.

In such an object processing device, this best mode is characterized in that titanium is used for portions to be in contact with a liquid and portions to be in contact with a vapor of the water vapor generator 113 (including a heater for heating pure water) and that the surface of the titanium is covered with an oxidized titanium film. First of all, a titanium material to be used may be of any of the grades defined by JIS, instead of an expensive, high-purity titanium material. By using such a low-cost material instead of an expensive, high-purity titanium material, a significant decrease in cost may be realized. Chemical components and mechanical properties of titanium in JIS grades are shown in the table. Three classes of titanium for industrial uses contain 0.3% (maximum) of iron in addition to 0.7% (maximum) each of Al, Cr, Ni, Si and Sn. For portions to be in contact with a liquid, a low-metal elution, non-metallic material such as Teflon (Teflon is a registered trademark) may be used in portions where the temperature is below 100° C. In addition, for portions at 100° C. or higher, it is usable when piping components (joints, valves, pipings and the like) use a low-metal elution, non-metallic material. In addition, quartz may be mentioned as a clean material that may be used at high temperatures. Quartz is, however, limited to partial uses because titanium and clean, heat-resistant resins such as Teflon (Teflon is a registered trademark) are superior in terms of cost, processability and strength.

TABLE 1

| | | | | | | mechanical properties | | |
|---|---|---|---|---|---|---|---|---|
| | chemical components (% max) | | | | | tensile | yield | elongation |
| grade | H | O | N | Fe | Ti | strength (MPa) | strength (MPa) | (%) |
| pure titanium | 0.015 | 0.15 | 0.05 | 0.2 | balance | 270 to 410 | >=165 | >=27 |
| JIS class 1 | | | | | | | | |
| pure titanium | 0.015 | 0.2 | 0.05 | 0.25 | balance | 340 to 510 | >=215 | >=23 |
| JIS class 2 | | | | | | | | |
| pure titanium | 0.015 | 0.3 | 0.07 | 0.3 | balance | 480 to 620 | >=345 | >=18 |
| JIS class 3 | | | | | | | | |
| pure titanium | 0.015 | 0.4 | 0.07 | 0.5 | balance | 550 to 750 | >=485 | >=15 |
| JIS class 4 | | | | | | | | |

Here, when the titanium material used is not of a high purity, that is, when metal molecules and contaminants other than titanium that have been contained in or adsorbed to the titanium material during such steps as refining, grinding, processing and welding the titanium material are present in considerable amounts, it is preferable to remove them from the titanium surface through an acid wash step and a flushing step using deionized water (first surface treatment). By carrying out such a surface treatment, it will be possible to increase the purity or cleanness of the titanium surface even when a titanium material with a relatively low purity is used. Here, for acid wash to be carried out, the species of acids (for example, dilute hydrochloric acid, dilute nitric acid, dilute hydrofluoric acid) are determined appropriately on the basis of technical common sense according to the metal to be removed. For cleaning a titanium material containing a large amount of iron, for example, dilute hydrochloric acid is preferably used.

In addition, it is preferable to remove minute impurities remaining on the surface with the use of heated pure water (100° C. or higher) and heated vapor (second surface treatment). Specifically, it is preferable to carry out a purge treatment, called maturing, involving pure water heating and vapor for further improving purity and cleanness of the titanium surface. The “pure water” here may be so-called water (pure water) characterized as pure water or ultrapure water used in a cleaning step and the like for semiconductor device fabrication. Concurrent with this second surface treatment, the oxidized titanium film will be formed.

By treating the titanium material with the first surface treatment and/or the second surface treatment, unwanted metallic impurities will be removed from the titanium surface so that the titanium surface may be covered with an oxidized titanium film containing a minimum amount of metallic impurities. The surfaces to be in contact with a liquid or vapor of the vapor generator on which the film has been formed have minimum metallic impurities, so that their elution may be minimized. In this manner, the first surface treatment and the second surface treatment utilize the mechanism of selectively cleaning the titanium surface by virtue of the difference in solubility of titanium and metallic impurities and the like contained in the titanium to acids, pure water and vapor.

The conditions for the second surface treatment are not limited and are appropriately determined by those skilled in the art depending on applications. For example, when water vapor at 150° C. is fed continuously for 16 hours, an oxidized titanium film of about 10 to 20 nm will be formed. In addition, an oxidized titanium film can also be formed with immersion in water much lower in temperature than that. For example, shown in FIG. 4 are a titanium oxide film formed from immersion in warm water at 60° C. for 6 hours (A in the figure) and a titanium oxide film formed from immersion in pure water at an ordinary temperature for 6 hours (B in the figure). As seen from the figure, the oxide films are made thicker at the higher temperature of 60° C.

The oxidized titanium film, a naturally oxidized film formed by such treatments, is stable in a variety of environments (for example, highly heat-resistant and corrosion-resistant) and prevents elution of impurities remaining in a minimum amount in a titanium material and contamination to the titanium material. Further, the strength of the titanium material will not be degraded by the formation of the oxidized titanium film. In addition, this titanium film is highly hydrophilic and effective in promoting heat conduction between a heater and pure water and preventing the heater from overheating to extend the service life of the heater.

Incidentally, although an oxidized titanium film is naturally formed, it is suitable from a viewpoint of forming a more rigid oxide film to treat a titanium material by heating (for example, 100° C. or higher) under the presence of oxygen (for example, second surface treatment). In addition, it is suitable that the oxidized titanium film is formed after the first surface treatment and/or the second surface treatment have been made or is formed simultaneously with the first surface treatment and/or the second surface treatment, because it minimizes the content of impurities in the oxidized film itself.

Second Best Mode

The basic principles of this best mode will first be described. According to the natural law, the boiling point of a liquid increases in proportion to pressure. Specifically, the pressure within a pressurized warm water supply device is set higher than the atmospheric pressure while maintaining the pressurized warm water in a liquid state in the pressurized warm water supply device and the pressurized warm water is spurted under the atmospheric pressure or a reduced pressure to thereby create a rapid boiling phenomenon (phreatic explosion).

Next, with reference to FIG. 3, an overall configuration of a semiconductor processing device according to a second best mode will now be described. The device is composed of a nozzle 301, an operative valve 303, a water flowmeter 305, a pressure meter 307, a heater 309, a pressurized warm water supply device 311, a water supply pipe 315, a pressure-resistant pipe 321 and a stage 331. Positioned on the stage 331 is an object to be processed (for example, a semiconductor wafer) 333. The nozzle 301 is positioned so as to face the object 333 and generates a pressurized warm water jet.

The heater 309 heats the pure water in the pressurized warm water supply device 311. Since the heated pure water generates water vapor, the pressure A₂ (MP) within the pressurized warm water supply device 311 will be higher than the atmospheric pressure. A predetermined flow rate B₂ (l/min) of the pressurized pure water is fed under a high pressure through the pressure-resistant pipe 321 to the nozzle 301.

The water flowmeter 305 measures the flow rate of the pure water supplied from the pressurized warm water supply device 311 to the nozzle 301. The operator can confirm the flow rate at the water flowmeter 305 and adjust it to a desired value using the operative valve 303. In addition, a stop valve (not shown) may be opened or closed to stop or resume the supply of the pure water. The pressure meter 307 measures the pressure within the pressurized warm water supply device 311. The operator confirms the pressure at the pressure meter 307. The water vapor supply pipe 315 can refill the water vapor generated within the pressurized warm water supply device 311 with pure water at an ordinary temperature and simultaneously adjust the temperature within the pressurized warm water supply device 311 to a desired value.

The pressurized warm water supplied through the pressure-resistant pipe 321 to the nozzle 301 is spurted through the jet port of the nozzle 301, causing a rapid boiling phenomenon (phreatic explosion), to be sprayed onto the surface of the object. The surface of the object is eroded and then treated with cleaning, polishing or grinding.

Specific Numerical Values

(1) Specific numerical values within the pressurized warm water supply device 311

Pressure within the pressurized warm water supply device A₂ (MP)=0.1 to 0.5 (MP)

Flow rate of the pressurized warm water B₂ (l/min)=0.5 to 4.0

Temperature of the pressurized warm water C₂ (° C.)=110 to 150 (° C.)

(2) Distance between the surface of an object and the jet port of the nozzle 301 D₂=0 to 100 (mm)

In such an object processing device, this best mode is characterized in that titanium is used as the material for portions to be in contact with a liquid and portions to be in contact with a vapor of the pressurized warm water supply device 311 (including the heater 309) and that the surface of the titanium is covered with an oxidized titanium film. Details regarding titanium are the same as those set forth for the first best mode so that the description may be dispensed with.

### EXAMPLE

The present invention will specifically be described with reference to an example. The technical scope of the present invention is in no way limited to the example below.

First, the semiconductor processing device in the example is identical to the one shown in FIG. 1. Here, the nozzle 101, the operative valve 103, the stop valves 107a and 107b, the water pressurizing tank 111, the water vapor generator 113, the heater provided within the water vapor generator 113, the pressure reducing valve 119 and the pressure-resistant pipes 121 to 123 are made of titanium. Here, for production of each member, a titanium material of JIS Class 2 was used. After cleaning with dilute hydrochloric acid, dilute nitric acid and the like, the vapor pressure within the vessel was set to 0.3 MPa to carry out heating for 30 hours.

As a result of the treatment, the oxidized titanium film formed over each member had a thickness of 50 nm. Then the treated members were used to construct a semiconductor processing device and the vapor pressure was set at 0.3 MPa to operate the device for 30 seconds. As a result, the content of heavy metals in the washings was reduced to 1 ppb or less (for each metallic element alone, 0.1 ppb or less).

Further, the results of determination for contamination of wafer surfaces with the use of the washings are shown in FIG. 2. As seen from FIG. 2, when the members treated as described above were used, the amount of elution of each metal was reduced to a level at which no problems will occur for semiconductor processing.

TABLE 2
Unit: E9 atom/cm²

| | Wafer 2 | Wafer 1 |
|---|---|---|
| Fe | <2 | <2 |
| Cr | <2 | <2 |
| Ni | 5 | <4 |
| Cu | <2 | <2 |
| Na | <2 | <2 |
| K | <2 | <2 |
| Ca | 10 | 10 |
| Mg | 7 | 7 |
| Zn | 5 | 7 |
| Al | <6 | <6 |
| Mn | <2 | <2 |
| Ti | <2 | <2 |
| W | <2 | <2 |
| Pb | <2 | <2 |
| Pt | <2 | <2 |
| Ir | <2 | <2 |
| Sr | <2 | <2 |
| Bi | <2 | <2 |
| Ba | <2 | <2 |
| Y | <2 | <2 |
| Cs | <2 | <2 |
| Mo | <2 | <2 |
| Zr | <2 | <2 |

### BRIEF DESCRIPTION OF THE DRAWINGS

FIG. 1 is a schematic diagram illustrating an overall configuration of a semiconductor processing device according to a first best mode of the present invention;

FIG. 2(a) is a diagram illustrating a specific shape of a nozzle in a semiconductor processing device according to the first best mode of the present invention;

FIG. 2(b) is a diagram illustrating a specific shape of a nozzle in a semiconductor processing device according to the first best mode of the present invention;

FIG. 3 is a schematic diagram illustrating the overall configuration of a semiconductor processing device according to the second best mode of the present invention;

FIG. 4 shows results of experiments for validating increases in oxidized titanium film thicknesses when titanium materials are immersed in ultrapure water at 60° C. and an ordinary temperature for six hours;

FIG. 5 illustrates a type of vapor generator (directly heating pure water by heater);

FIG. 6 illustrates a type of vapor generator (radiantly heating pure water by heater); and

FIG. 7 illustrates a type of vapor generator (indirectly heating pure water by heater).

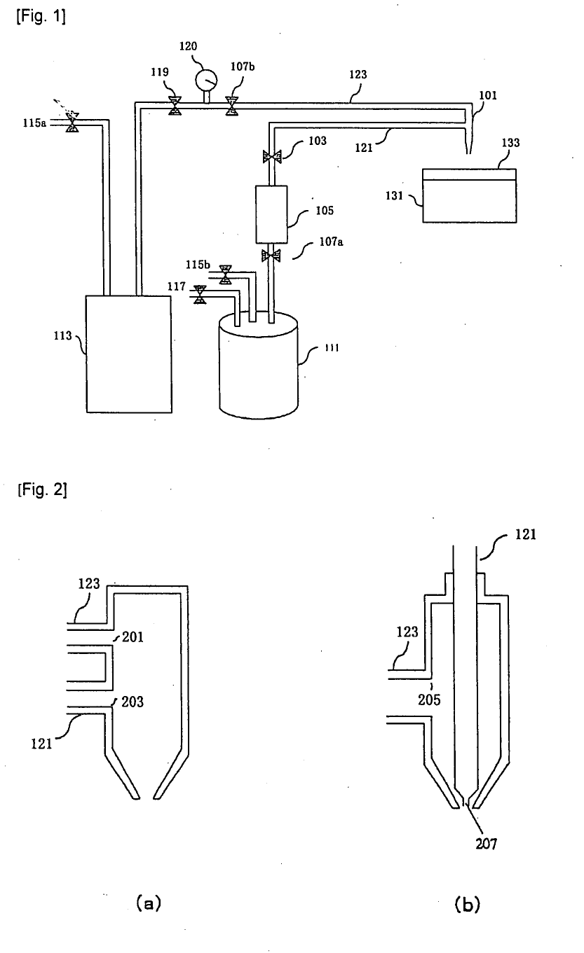

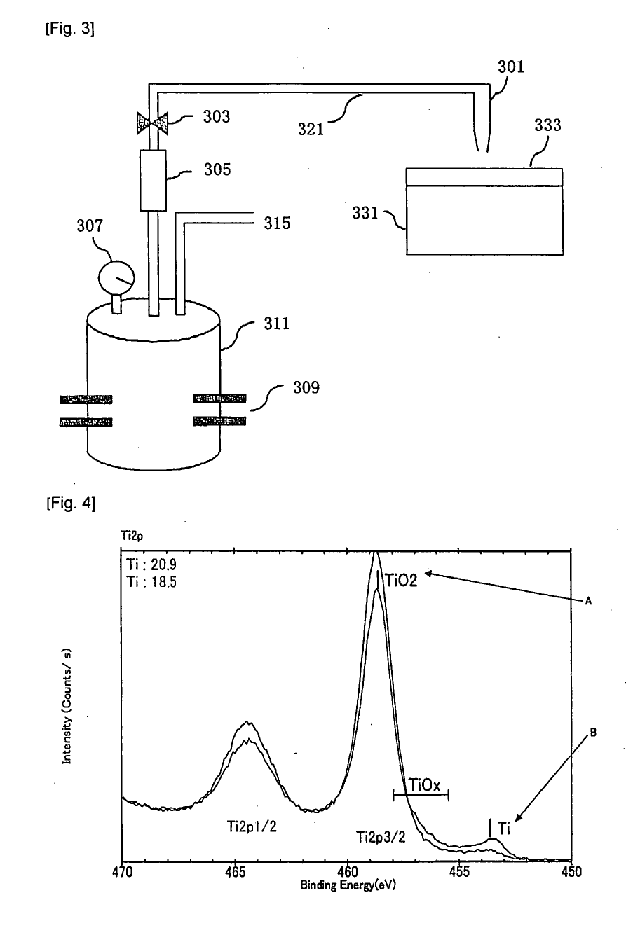

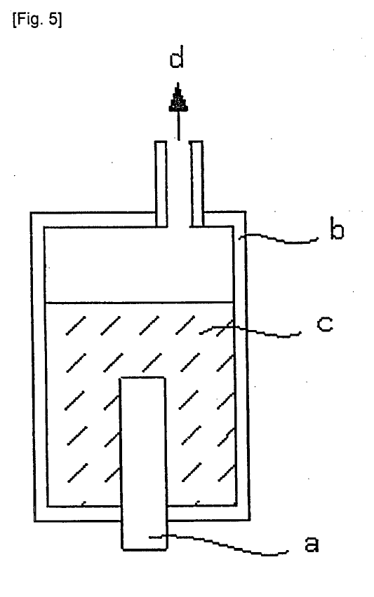

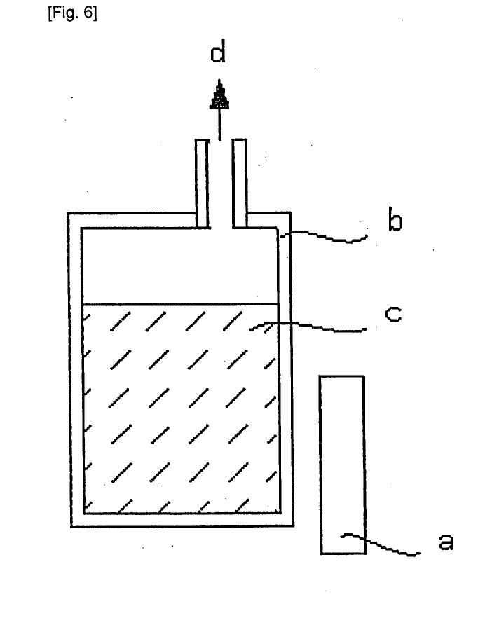

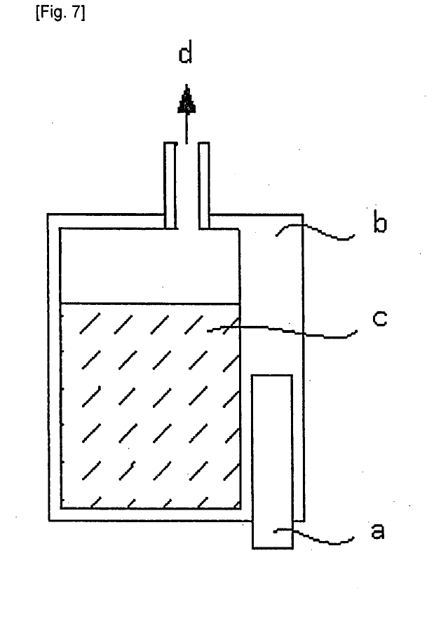

1-11. (canceled)

12. A device for performing cleaning, delamination or processing of a semiconductor substrate by using vapor of pure water, which comprises a vapor generator and a component related thereto, in which the vapor generator and the component related thereto are partially or wholly composed of titanium material, and a titanium oxide film is formed by treating the titanium material with vapor of pure water on the surface the titanium material.

13. The device according to claim 12, the titanium oxide film is formed by assembling the device under the condition that the titanium oxide film is not formed on the surface of the titanium material, followed by bringing the device into operation to treat the titanium material with vapor of pure water.

14. The device according to claim 12, wherein the vapor generator and the component related thereto include vessels of a vapor generator, heaters, safety valves, stop valves, pressure reducing valves, orifices for regulating vapor flow rate, pressure detectors, pure water level detectors or pipings for vapor.

15. The device according to claim 12, wherein the vapor generator and the component related thereto include a heater of the type of directly heating pure water.

16. The device according to claim 12, wherein the surface of the titanium is cleaned with an acid prior to the formation of the titanium oxide film.

17. The device according to claim 12, wherein the titanium oxide film indispensably contains titanium monooxide.

18. The device according to claim 12, wherein the thickness of the titanium oxide film is 5 nm or more.

19. The device according to claim 12, wherein the thickness of the titanium oxide film is 7.5 nm or more.

20. The device according to claim 12, wherein the thickness of the titanium oxide film is 10 nm or more.

21. The device according to claim 12, wherein the vapor of pure water used for cleaning, delamination or processing of the semiconductor substrate is the vapor jet or a mixed jet of the vapor and pure water.

22. The device according to claim 12, wherein the vapor of pure water used for forming the titanium oxide film is the vapor jet or a mixed jet of the vapor and pure water.

23. The device according to claim 22, wherein the temperature of the pure water is 100° or higher in the case that the mixed jet is used for forming the titanium oxide film.
